(19) United States
(12) Patent Application Publication
(10) Pub. No.: US 2026/0368107 A1
(43) Pub. Date: Nov. 19, 2026

(54) MULTIPLE DEVICE

(71) Applicant: KOA CORPORATION, Nagano (JP)

(72) Inventor: Yasutaka FUJII, Nagano (JP)

(73) Assignee: KOA CORPORATION, Nagano (JP)

(21) Appl. No.: 19/154,953

(22) PCT Filed: Jan. 18, 2024
(86) PCT No.: PCT/JP2024/001181

§ 371 Date: Aug. 8, 2025

(30) Foreign Application Priority Data
Feb. 15, 2023 (JP) 2023-021479

(51) Int. Cl. G06F 13/10

(52) U.S. Cl. CPC G06F 13/102

(57) ABSTRACT

An object is to provide a multiple device capable of performing synchronization easily and accurately without requiring complicated correction processing of software. The multiple device according to the present invention includes a plurality of devices including an upper device, a lower device, and one or more intermediate devices positioned between the upper device and the lower device, in which the devices are connected in series via a communication line, and data transmission and reception are performed between the devices, a data acquisition request command for controlling a timing of acquiring predetermined data is associated with each device, the data acquisition request command is transmitted earlier as the device is farther from the upper device, and all the data acquisition request commands for the intermediate devices are sequentially transmitted before the data acquisition request command reaches the lower device.

### TECHNICAL FIELD

The present invention relates to a multiple device.

### BACKGROUND ART

Patent Literature 1 discloses an invention related to a multiple-type sensor in which a plurality of sensor units are daisy-chained. Patent Literature 1 describes that communication can be performed between adjacent sensor units or between a host and a sensor unit, and communication quality can be appropriately maintained.

CITATION LIST

### Patent Literature

Patent Literature 1: JP 2019-50502 A

Patent Literature 2: JP 2012-238341 A

Patent Literature 3: JP 2004-88208 A

Patent Literature 4: JP 2016-66278 A

Patent Literature 5: JP H10-13394 A

### SUMMARY OF INVENTION

### Technical Problem

Patent Literature 1 does not describe synchronization of data acquisition. Meanwhile, a technique for achieving synchronization using a common synchronization signal line described in Patent Literatures 2 to 4 is widely known (See FIG. 1 of Patent Literature 2, FIG. 3 of Patent Literature 3, FIG. 1 of Patent Literature 4, and the like).

However, there is a problem that the number of devices connected and the distance between the devices are limited by the driving force of the common synchronization signal line.

Meanwhile, in Patent Literature 5, a type and a length of a transmission line are input to an apparatus (device) to obtain a propagation delay time by the transmission line, and a correction amount is obtained from the propagation delay time.

However, since the propagation delay time differs depending on each device, correction of the propagation delay time for a large number of devices requires complicated correction processing, and a load of software is large.

An object of the present invention is to provide a multiple device capable of performing synchronization easily and accurately without requiring a dedicated signal for synchronization or complicated correction processing of software.

### Solution to Problem

A multiple device according to the present invention includes a plurality of devices including an upper device, a lower device, and one or more intermediate devices positioned between the upper device and the lower device, in which the devices are connected in series via a communication line, and data transmission and reception are performed between the devices, a data acquisition request command for controlling a timing of acquiring predetermined data from each device is associated with each device, the data acquisition request command is transmitted earlier as the device is farther from the upper device, and all the data acquisition request commands for the intermediate devices are sequentially transmitted before the data acquisition request command reaches the lower device.

In the present invention, it is preferable that the data acquisition request command is transmitted to a device on a lower side between the devices, and then the next data acquisition request command is subsequently transmitted to the device on the lower side.

In the present invention, it is preferable that the upper device is a host device, and the intermediate device and the lower device are sensor devices that detect a wind.

### Advantageous Effects of Invention

According to the present invention, it is possible to implement a multiple device capable of performing synchronization easily and accurately without requiring a dedicated signal for synchronization or complicated correction processing of software and matching sensor detection timings.

### BRIEF DESCRIPTION OF DRAWINGS

FIG. 1 is a schematic diagram of a multiple device according to the present embodiment.

FIG. 2 is a conceptual diagram illustrating a problem in command transmission of a multiple device of a comparative example.

FIG. 3 illustrates an example of command transmission of the multiple device according to the present embodiment.

FIG. 4 is an example of a communication block diagram of the multiple device according to the present embodiment.

FIG. 5 is an example of a circuit diagram of a sensor.

### DESCRIPTION OF EMBODIMENTS

Below, an embodiment of the present invention (hereinafter simply referred to as an “embodiment”) is described in detail. Note that the present invention is not limited to the following embodiment, and various modifications can be made within the scope of the gist thereof.

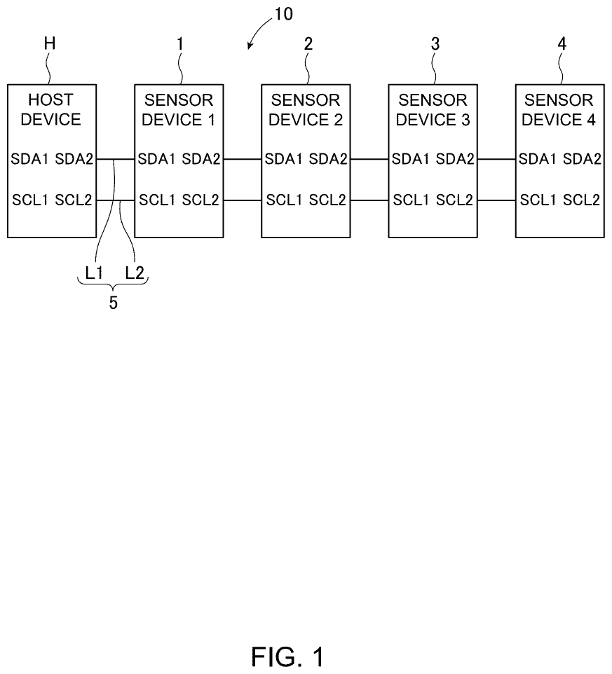

FIG. 1 is a schematic diagram of a multiple device 10 according to the present embodiment.

As illustrated in FIG. 1, the multiple device 10 according to the present embodiment includes a host device H and a plurality of sensor devices 1 to 4. In the present specification, the host device H and the sensor devices 1 to 4 are not distinctive and are referred to as “devices” in some cases. In addition, the host device H may be referred to as an “upper device”, the sensor device 4 may be referred to as a “lower device”, and the sensor devices 1 to 3 may be referred to as “intermediate devices”. In addition, the “lower-side device” refers to a device on a side closer to the “lower device” between the adjacent devices.

As illustrated in FIG. 1, each device separately illustrates a signal line L1 for exchanging a data signal (SDA) and a signal line L2 for exchanging a clock signal (SCL), but these signal lines L1 and L2 can be combined to configure a communication line 5, and the devices are connected in series by the communication line 5.

The host device H is a microcomputer that controls data transfer to the sensor devices 1 to 4 and means an apparatus serving as a master in communication. For example, the host device H is a personal computer, a server, a router, or the like. Also, the sensor devices 1 to 4 are microcomputers that control sensors, LEDs, and the like and mean apparatuses serving as slaves in communication.

In the present embodiment, in the sensor devices 1 to 4, for example, physical quantity data can be acquired, specifically, flow rate data can be acquired. In particular, in the present embodiment, the multiple device 10 capable of acquiring wind speed data can be provided.

In the present embodiment, the devices are connected in series via the communication line 5, enabling data transmission and reception between the devices.

In the sensor devices 1 to 4, the timing of acquiring the sensor data is when a data acquisition request command (a command of a sensor data acquisition trigger) sent from the host device H is received, but in the present embodiment, the data acquisition request commands received by the sensor devices 1 to 4 are controlled to be substantially the same timings, and it is possible to improve a problem that a time deviation occurs in data acquisition.

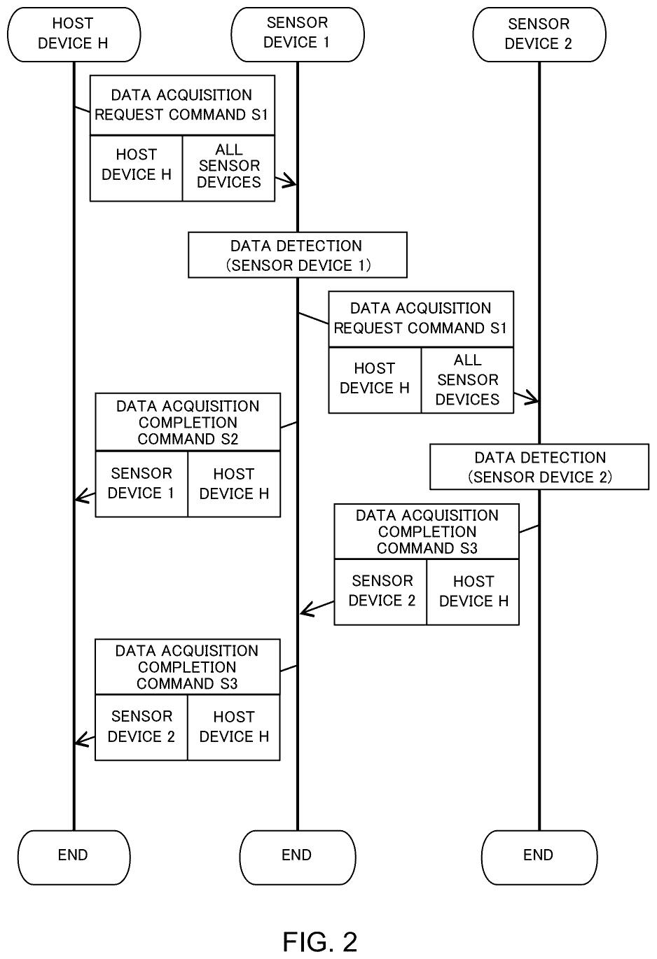

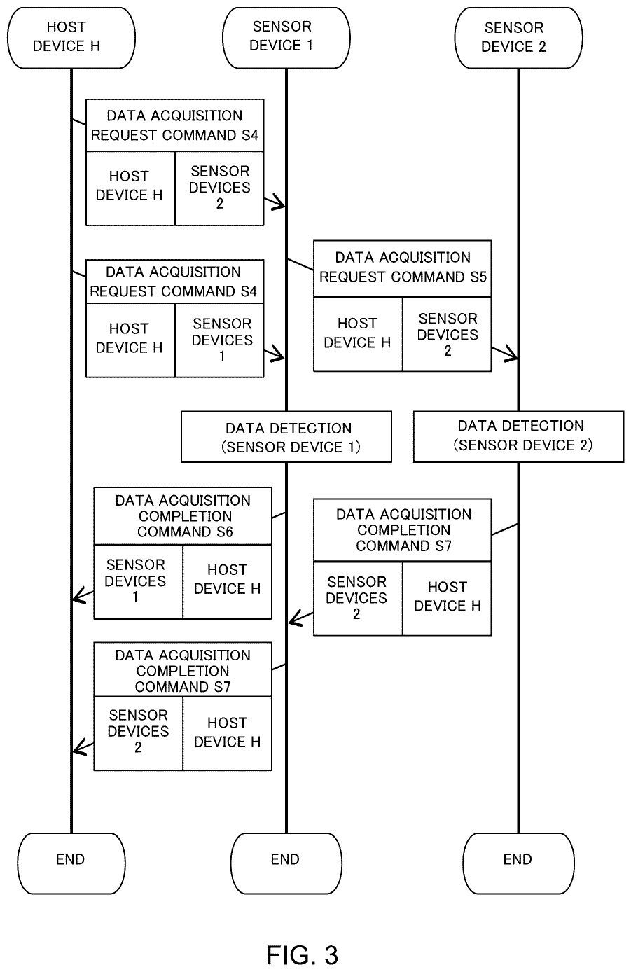

Hereinafter, the command transmission is described. First, a comparative example in which the timings of the data acquisition request commands are deviated with respect to the sensor devices is described with reference to FIG. 2. Note that, in FIGS. 2 and 3, only the host device H, the sensor device 1, and the sensor device 2 are illustrated and described in order to simplify the description. The vertical direction in FIGS. 2 and 3 indicates time series, and time advances from the top to the bottom in the drawing.

As illustrated in FIG. 2, a data acquisition request command S1 is transmitted from the host device H to the sensor device 1. Note that, in FIGS. 2 and 3, an upper field of a box display indicates a type of command, a lower left field indicates a transmission source, and a lower right field indicates a reception destination.

As illustrated in FIG. 2, the data acquisition request command S1 is a command from the host device H to all the sensor devices. Therefore, as illustrated in FIG. 2, the sensor device 1 that receives the data acquisition request command S1 from the host device H performs predetermined data detection at that timing and transmits the data acquisition request command S1 from the sensor device 1 to the sensor device 2.

Then, as illustrated in FIG. 2, the sensor device 2 that receives the data acquisition request command S1 from the sensor device 1 performs predetermined data detection later than the data acquisition timing by the sensor device 1.

Note that data acquisition completion commands S2 and S3 are sent from the sensor device 1 and the sensor device 2 that complete data detection to the host device H.

As described above, in the comparative example of FIG. 2, the data acquisition request command S1 sent from the host device H to the sensor devices 1 and 2 is an instruction for all the sensor devices, and communication is performed in a so-called bucket relay system. Therefore, as the sensor device is closer to the host device H and receives the data acquisition request command S1 earlier, data detection is performed earlier, thereby causing a time deviation in the data detection.

Such a time deviation of data detection similarly occurs in the configuration using the common synchronization signal line described in the patent literature. That is, since the instruction to the sensor device connected far from the host device arrives later than the sensor device connected near the host device, the data acquisition timing does not match in each sensor device, and the timing deviation increases as the common synchronization signal line becomes longer, and it becomes impossible to exhibit the sensor function at the same timing such as acquisition of the sensor data at the same time in each sensor device or illumination of the LED at the same time.

Therefore, in the present embodiment, the transfer control of the data acquisition request command is improved as follows in order to improve the problem that, the data acquisition timing is more delayed as the sensor device is separated farther from the host device H, and thus a time deviation occurs in the data acquisition.

That is, in the present embodiment, the data acquisition request command is associated with each device. In the present embodiment, a data acquisition request command S4 illustrated in FIG. 3 is associated with the data acquisition timing of the sensor device 2, and a data acquisition request command S5 is associated with the data acquisition timing of the sensor device 1. Therefore, the sensor device 2 executes data acquisition at the timing of receiving the data acquisition request command S4, and the sensor device 1 executes data acquisition at the timing of receiving the data acquisition request command S5.

Then, as illustrated in FIG. 3, a data acquisition request command for the sensor device separated farthest from the host device H is transmitted at the earliest. In the sensor device 1 and the sensor device 2 illustrated in FIG. 3, since the sensor device 2 is farther away from the host device H than the sensor device 1, the data acquisition request command S4 for the sensor device 2 is transmitted earlier.

That is, as illustrated in FIG. 3, the data acquisition request command S4 is sent from the host device H to the sensor device 1, and further the sensor device 1 transfers the data acquisition request command S4 to the sensor device 2.

At this time, immediately after the data acquisition request command S4 is transferred from the sensor device 1 to the sensor device 2, the data acquisition request command S5 for the sensor device 1 is transmitted from the host device H to the sensor device 1.

In this manner, after the data acquisition request command S4 is transmitted from the host device H to the adjacent sensor device 1, the next data acquisition request command S5 is subsequently transmitted from the host device H to the adjacent sensor device 1. At this time, the host device H can transmit the data acquisition request command S5 immediately after receiving an Ack signal indicating that the sensor device 1 has received the data acquisition request command S4.

As described above, by performing the transfer control of the data acquisition request command, the timing at which the sensor device 2 receives the data acquisition request command S4 and the timing at which the sensor device 1 receives the data acquisition request command S5 can be made substantially the same as illustrated in FIG. 3. As a result, the time deviation between the data detection by the sensor device 1 and the data detection by the sensor device 2 can be made substantially zero and can be made at least smaller than the case in the related art.

As illustrated in FIG. 3, the sensor device 1 and the sensor device 2 send data acquisition completion commands S6 and S7 to the host device H. Then, the host device H processes the sensor detection signals of the sensor device 1 and the sensor device 2 obtained at the same timing.

As described above, in FIG. 1, the host device H issues a data acquisition request command to the sensor device 4 connected farthest. Then, when the sensor device 1 adjacent to the host device H receives the data acquisition request command, the host device immediately issues the data acquisition request command for the sensor device 3 second farthest from the host device H. Each device transfers each data acquisition request command to the sensor device associated with the data acquisition request command, and the data acquisition request command for each sensor device also arrives at each of the sensor devices 1 to 3 just at the timing when the data acquisition request command for the sensor device 4 reaches the farthest sensor device 4. As described above, since the timings at which the data acquisition request commands reach the sensor devices can be made substantially the same, the time deviation of the sensor detection can be made smaller than that in the related art.

In the present embodiment, regardless of the number of the sensor devices connected, the time deviation of the sensor detection can be reduced. Although not limited, even if the number of sensor devices is in a range of several hundreds to several thousands, synchronization can be appropriately performed.

When the number of connected sensor devices increases, the distance between the host device H and the sensor device farthest from the host device H increases. However, in the present embodiment, since the system is a system in which the devices are connected by the communication line 5, and data transmission and reception between the devices can be performed, even if the total communication distance is longer than that in the system using the common synchronization signal in the related art, the synchronization can be appropriately achieved by performing the transfer control of the data acquisition request command in the present embodiment.

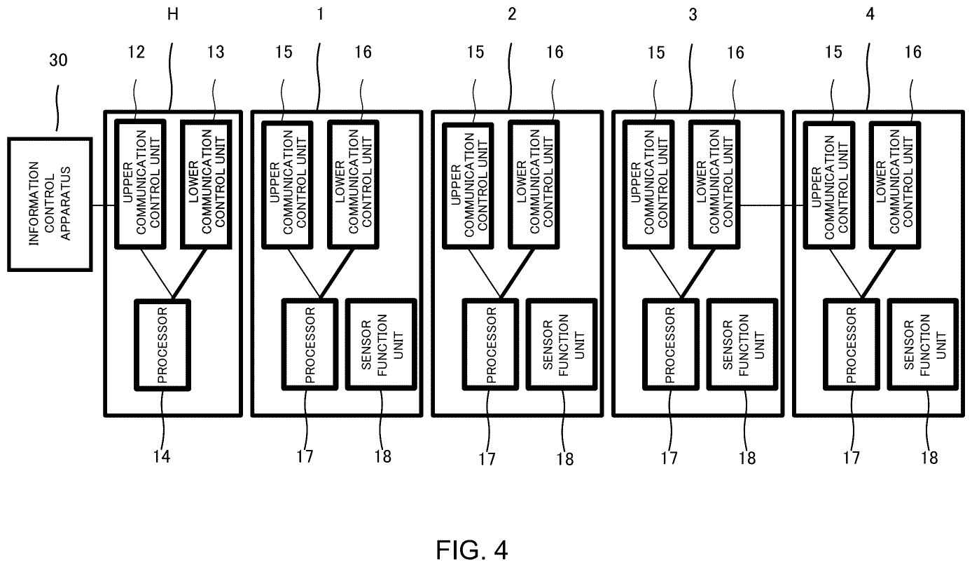

FIG. 4 is a communication block diagram of the multiple device according to the present embodiment. As illustrated in FIG. 4, the host device H is configured with an upper communication control unit 12, a lower communication control unit 13, and a processor 14. Furthermore, each of the sensor devices 1 to 4 is configured with an upper communication control unit 15, a lower communication control unit 16, a processor 17, and a sensor function unit 18.

As described above, each of the host devices H and each of the sensor devices 1 to 4 respectively include two communication control units of the upper communication control units 12 and 15 and the lower communication control units 13 and 16.

The upper communication control unit 12 of the host device H is connected to an information control apparatus 30 such as a PC, and the lower communication control unit 13 of the host device H performs transmission and reception control with the sensor device 1 positioned on the lower side.

Similarly, each lower communication control unit 16 of each of the sensor devices 1 to 4 is connected to the upper communication control unit 15 of the sensor device positioned on the lower side and performs transmission and reception control between the sensor devices.

Note that the processor 14 provided in the host device H controls a command from the information control apparatus 30 and performs various processes on data from the sensor devices 1 to 4.

In addition, the processor 17 provided in each of the sensor devices 1 to 4 performs various processes such as a process of writing data by sensor output in a host transmission memory and a process based on a command from the host device H.

The sensor function unit 18 provided in each of the sensor devices 1 to 4 illustrated in FIG. 4 is a functional unit that acquires data. For example, in the case of a wind sensor that detects wind, the sensor is configured as follows.

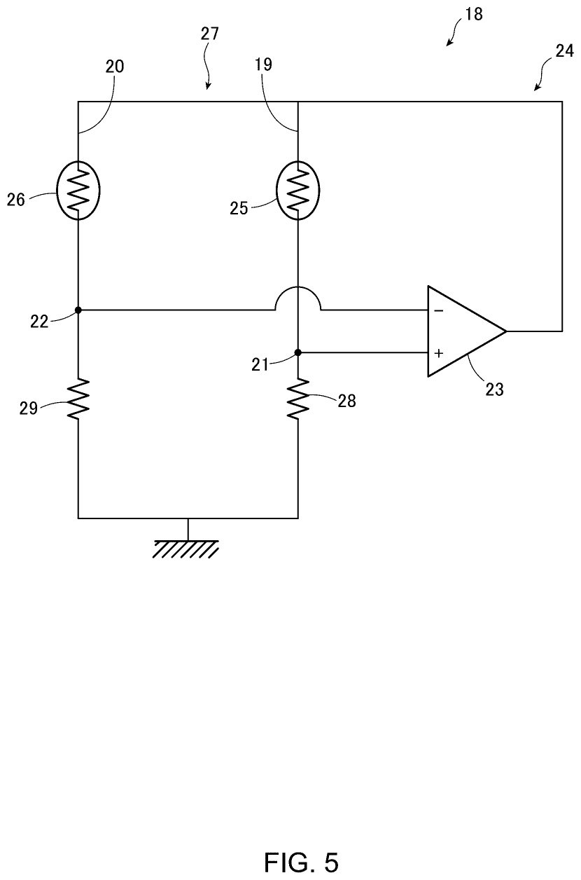

FIG. 5 is an example of a circuit diagram of a sensor function unit.

As illustrated in FIG. 5, in the sensor function unit, a bridge circuit 27 is configured with a flow rate detecting resistance element 25, a temperature compensating resistance element 26, and resistors 28 and 29. As illustrated in FIG. 5, a first series circuit 19 is configured with the flow rate detecting resistance element 25 and the resistor 28, and a second series circuit 20 is configured with the temperature compensating resistance element 26 and the resistor 29. Then, the first series circuit 19 and the second series circuit 20 are connected in parallel and configure the bridge circuit 27.

As illustrated in FIG. 5, an output unit 21 of the first series circuit 19 and an output unit 22 of the second series circuit 20 each are connected to a differential amplifier (amp) 23. A feedback circuit 24 including the differential amplifier 23 is connected to the bridge circuit 27. The feedback circuit 24 includes a transistor (not illustrated) and the like.

The resistors 28 and 29 have lower temperature coefficients of resistance (TCR) than those of the flow rate detecting resistance element 25 and the temperature compensating resistance element 26. The flow rate detecting resistance element 25 is controlled to have, for example, a predetermined resistance value Rs1 in a heating state controlled to be higher than a predetermined ambient temperature by a predetermined value, and the temperature compensating resistance element 26 is controlled to have, for example, a predetermined resistance value Rs2 at the ambient temperature. Note that the resistance value Rs1 is smaller than the resistance value Rs2. The resistor 28 that configures the first series circuit 19 together with the flow rate detecting resistance element 25 is, for example, a fixed resistor having a resistance value R1 similar to the resistance value Rs1 of the flow rate detecting resistance element 25. Furthermore, the resistor 29 that configures the second series circuit 20 together with the temperature compensating resistance element 26 is a fixed resistor having a resistance value R2 similar to the resistance value Rs2 of the temperature compensating resistance element 26.

When the wind acts on the flow rate detecting resistance element 25, the temperature of the flow rate detecting resistance element 25 that is a heating resistor decreases, and thus the potential of the output unit 21 of the first series circuit 19 to which the flow rate detecting resistance element 25 is connected varies. As a result, a differential output is obtained by the differential amplifier 23. Also, the feedback circuit 24 applies a drive voltage to the flow rate detecting resistance element 25 based on the differential output. Then, the wind speed can be converted and output by a microcomputer described below based on a change in voltage required for heating the flow rate detecting resistance element 25.

As described above, in the present embodiment, in the host device H and the sensor devices 1 to 4, the communication control unit is divided into the upper communication control unit and the lower communication control unit, whereby the host device H and the sensor devices 1 to 4 can be daisy-chained, and command transmission and data transmission and reception can be performed only between adjacent devices. As a result, by performing communication control in which (1) a data acquisition request command is associated with each device, (2) the data acquisition request command is transmitted earlier as the device is farther from the upper device, and (3) all the data acquisition request commands for the intermediate devices are sequentially transmitted before the data acquisition request command reaches the lower device, even if the number of device connections increases, synchronization can be appropriately performed, and thus sensor detection can be performed at substantially the same timing.

### INDUSTRIAL APPLICABILITY

In particular, the present invention can provide a multiple device that is optimal for performing sensor detection at the same timing. The multiple device of the present invention is, for example, a multiple device that detects wind and can be applied regardless of indoor or outdoor use. The multiple device can be used, for example, for air conditioning equipment, illumination, and experiment/analysis.

The present application is based on Japanese Patent Application No. 2023-021479 filed on Feb. 15, 2023. The entire contents thereof are incorporated herein by reference.

1. A multiple device comprising: a plurality of devices including an upper device, a lower device, and one or more intermediate devices positioned between the upper device and the lower device,
wherein the devices are connected in series via a communication line, and data transmission and reception are performed between the devices,
a data acquisition request command for controlling a timing of acquiring predetermined data is associated with each device, the data acquisition request command is transmitted earlier as the device is farther from the upper device, and all the data acquisition request commands for the intermediate devices are sequentially transmitted before the data acquisition request command reaches the lower device.

2. The multiple device according to claim 1, wherein the data acquisition request command is transmitted to a device on a lower side between the devices, and then the next data acquisition request command is subsequently transmitted to the device on the lower side.

3. The multiple device according to claim 1, wherein the upper device is a host device, and the intermediate device and the lower device are sensor devices that detect a wind.
